(19) United States
(12) Patent Application Publication
(10) Pub. No.: US 2001/0032150 A1
(43) Pub. Date: Oct. 18, 2001

(54) Online shopping method and online shopping system

(75) Inventor: Masaru Terashima, Tokyo (JP)

Correspondence Address: Paul J. Esatto, Jr., Scully, Scott, Murphy & Presser, 400 Garden City Plaza, Garden City, NY, 11530, US

(73) Assignee: NEC Corporation, Tokyo (JP)

(21) Appl. No.: 09/833,530

(22) Filed: Apr. 12, 2001

(30) Foreign Application Priority Data
Apr. 14, 2000 (JP) 2000-112879

(51) Int. Cl. G06F 17/60

(52) U.S. Cl. 705/26; 705/44

(57) ABSTRACT

An online shopping method comprising steps of: transmitting identification information on a dealer from a dealer server to a purchaser terminal; transmitting the identification information on the dealer from the purchaser terminal to an authentication server; retrieving credibility information on the dealer corresponding to the identification information on the dealer by the authentication server; transmitting identification information on the purchaser from the purchaser terminal to the dealer server; transmitting identification information on the dealer from the authentication server to the purchaser terminal; transmitting the identification information on the purchaser from the dealer server to the authentication server; retrieving credibility information on the purchaser corresponding to the identification information on the purchaser by the authentication server; and transmitting the credibility information on the purchaser from the authentication server to the dealer server.

### BACKGROUND OF THE INVENTION

1. Field of the Invention

The present invention relates to a merchandise sales technique utilizing a network, and particularly, relates to an online shopping method capable of buying and selling merchandise more safely than conventional methods and a direct marketing system utilizing the network.

2. Description of Prior Art

In a conventional merchandise sales system for online shopping for merchandise using a network such as the Internet, a dealer receives an order of an article (or articles) from a purchaser through the network and the ordered article is delivered to an address designated by the orderer or purchaser from the dealer through a door-to-door delivery service.

FIG. 8 is a functional block diagram for describing the conventional merchandise sales system utilizing the network. Referring to FIG. 8, the conventional merchandise sales system consists of a purchaser terminal 110, a dealer server 120 provided to a dealer, a network 200 connecting the purchaser terminal 110 to the dealer server 120, a transport company 130 responsible for door-to-door delivery services and a financier 140 settling accounts.

The purchaser accesses a merchandise sales website opened on the network 200 by the dealer, decides on an article to be purchased and places an order with the dealer for the article on the screen of the terminal 110. At the time of the order, the purchaser designates purchase/order information including article identification information on the article which the purchaser wants to purchase, a method of the payment of the price of the article, article delivery place, and personal information such as an address and a name specifying the purchaser on the screen of the terminal 110.

The dealer server 120 which received the order, first checks the method of the payment of the article price. Then, if the payment method is account transfer using a credit card, the purchaser server 120 inquires of a credit firm dealing with the credit card based on personal information on the purchaser, checks whether there is any payment problem with the purchaser and then proceeds to an order process.

Next, the dealer directs a transport company 130 to deliver the article ordered by the purchaser to an address designated by the purchaser by telephone, FAX or the like. Following this direction, the transport company 130 goes to the warehouse of the dealer and gets the article and delivers the article to the designated delivery place.

The conventional technique has, however, the following disadvantages. First, if a purchaser should pay for the price of an article with a credit card, the purchaser informs a dealer of the purchaser's credit card number even though the purchaser does not know whether the dealer is trustworthy enough and there is a probability that the credit card is abused by a wicked dealer.

Second, if a purchaser should pay for the price of an article by bank account transfer in advance, the purchaser needs to transfer the price to a bank account designated by a dealer before receiving the article. However, there is a probability that a wicked dealer makes the purchaser transfer money but does not deliver the article.

Third, if a purchaser should pay for the price of an article by transferring money to the postal or bank account of a dealer using an account transfer sheet delivered to the purchaser together with the article, there is a possibility that a wicked purchaser receives the article but does not transfer money to the account of the dealer.

### SUMMARY OF THE INVENTION

The present invention has been made in view of the above-stated disadvantages. It is, therefore, an object of the present invention to provide an online shopping method capable of buying and selling merchandise more safely than conventional methods and a direct marketing system utilizing a network.

According to a first aspect of the present invention, there is provided an online shopping method comprising steps of: transmitting identification information on a dealer from a dealer server to a purchaser terminal; transmitting the identification information on the dealer from the purchaser terminal to an authentication server; retrieving credibility information on the dealer corresponding to the identification information on the dealer by the authentication server; and transmitting the credibility information on the dealer from the authentication server to the purchaser terminal.

In the method according to the first aspect, the credibility information on the dealer may include at least one of a company name, an address, main customers and annual sales of the dealer and a dealing status of the dealer with a correspondent financial institution.

According to a second aspect of the present invention, there is provided an online shopping method comprising steps of: transmitting identification information on a purchaser from a purchaser terminal to a dealer server; transmitting the identification information on the purchaser from the dealer server to an authentication server; retrieving credibility information on the purchaser corresponding to the identification information on the purchaser by the authentication server; and transmitting the credibility information on the purchaser from the authentication server to the dealer server.

In the method according to the second aspect, the credibility information on the purchaser may include at least one of an address, a name, and a telephone number of the purchaser and a dealing status of the purchaser with a credit firm.

According to a third aspect of the present invention, there is provided an online shopping method comprising steps of: transmitting identification information on a dealer from a dealer server to a purchaser terminal; transmitting the identification information on the dealer from the purchaser terminal to an authentication server; retrieving credibility information on the dealer corresponding to the identification information on the dealer by the authentication server; transmitting identification information on the purchaser from the purchaser terminal to the dealer server; transmitting identification information on the dealer from the authentication server to the purchaser terminal; transmitting the identification information on the purchaser from the dealer server to the authentication server; retrieving credibility information on the purchaser corresponding to the identification information on the purchaser by the authentication server; and transmitting the credibility information on the purchaser from the authentication server to the dealer server.

In the method according to the third aspect, the credibility information on the dealer may include at least one of a company name, an address, main customers, and annual sales of the dealer and a dealing status of the dealer with a financial institution.

In the method according to the third aspect, the credibility information on the purchaser may include at least one of an address, a name, a telephone number of the purchaser and a dealing status of the purchaser with a credit firm.

According to a fourth aspect of the present invention, there is provided an online shopping system comprising a purchaser terminal, a dealer server and an authentication server connected to one another through a network, wherein the dealer server comprises means for transmitting identification information on a dealer to the purchaser terminal; the purchaser terminal comprises means for transmitting identification information on the dealer to the authentication server; and the authentication server comprises: means for retrieving credibility information on the dealer corresponding to the identification information on the dealer, and means for transmitting the credibility information on the dealer to the purchaser terminal.

In the system according to the fourth aspect, the credibility information on the dealer may include at least one of a company name, an address, main customers, and annual sales of the dealer and a dealing status of the dealer with a financial institution.

According to a fifth aspect of the present invention, there is provided a online shopping system comprising a purchaser terminal, a dealer server and an authentication server connected to one another through a network, wherein the purchaser terminal comprises means for transmitting identification information on a purchaser from the purchaser terminal to the dealer server; the dealer server comprises means for transmitting the identification information on the purchaser from the dealer server to the authentication server; the authentication server comprises: means for retrieving credibility information on the purchaser corresponding to the identification information on the purchaser, and means for transmitting the credibility information on the purchaser to the dealer server.

In the system according to the fifth aspect, the credibility information on the purchaser may include at least one of an address, a name, and a telephone number of the purchaser and a dealing status of the purchaser with a credit firm.

According to a sixth aspect of the present invention, there is provided an online shopping system comprising a purchaser terminal, a dealer server and an authentication server connected to one another through a network, wherein the dealer server comprises means for transmitting identification information on a dealer to the purchaser terminal; the purchaser terminal comprises means for transmitting identification information on the dealer to the authentication server; the authentication server comprises: means for retrieving credibility information on the dealer corresponding to the identification information on the dealer, and means for transmitting the credibility information on the dealer to the purchaser terminal, and wherein the purchaser terminal comprises means for transmitting identification information on a purchaser to the dealer server; the dealer server comprises means for transmitting the identification information on the purchaser to the authentication server; and the authentication server comprises: means for retrieving credibility information on the purchaser corresponding to the identification information on the purchaser, and means for transmitting the credibility information on the purchaser to the dealer server.

In the system according to the sixth aspect, the credibility information on the dealer may include at least one of a company name, an address, main customers, and annual sales of the dealer and a dealing status of the dealer with a financial institution.

In the system according to the sixth aspect, the credibility information on the purchaser may include at least one of an address, a name, and a telephone number of the purchaser and a dealing status of the purchaser with a credit firm.

### BRIEF DESCRIPTION OF THE DRAWINGS

FIG. 1 is a functional block diagram for describing a direct marketing system utilizing a network according to one embodiment of the present invention;

FIG. 2 is a flow chart for describing an online shopping method utilizing the network according to one embodiment of the present invention;

FIG. 3 is an example of various items of article information displayed on a purchaser terminal;

FIG. 4 is an example of credibility information on a dealer displayed on the purchaser terminal;

FIG. 5 is an example of purchase/order information displayed on the purchaser terminal;

FIG. 6 is an example of credibility information on a purchaser displayed on a dealer server;

FIG. 7 is an example of information for checking the contents of the order of articles displayed on the purchaser terminal; and

FIG. 8 is a functional block diagram for describing a conventional merchandise sales system utilizing the network.

### DESCRIPTION OF THE EMBODIMENTS OF THE INVENTION

The present invention provides a merchandise sales business model with respect to a direct marketing system utilizing a network wherein a purchaser and a merchandise sales dealer acquire information on the other parties from an authentication server through the network at respective terminals (a purchaser terminal, a dealer server, a transport company terminal, a financier terminal and an authentication server) before purchasing and selling an article, thereby allowing the purchaser and the dealer to check the credibility of the other parties in advance before purchasing and selling the article, and also provides a merchandise sales business method for online shopping. The embodiments of the present invention will be described hereinafter in detail with reference to the accompanying drawings.

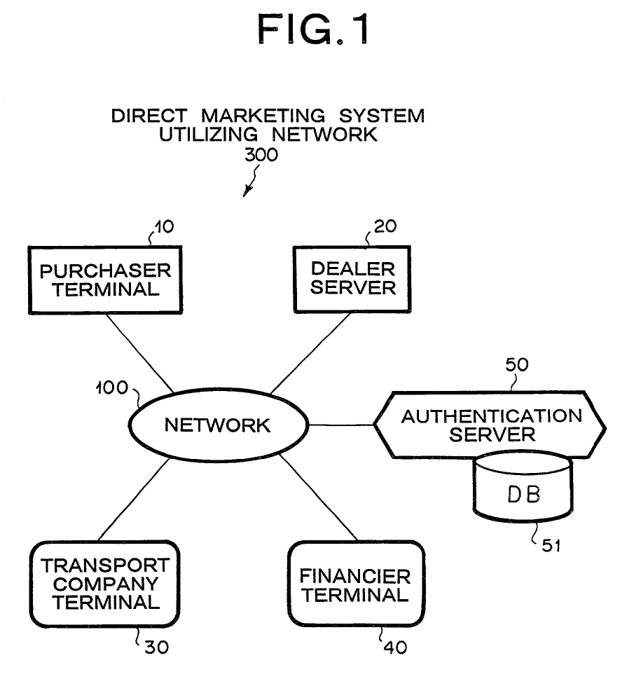

FIG. 1 is a functional block diagram for describing a direct marketing system 300 utilizing a network 100 according to one embodiment of the present invention. In FIG. 1, reference symbol 10 denotes a purchaser terminal, 20 denotes a dealer server, 30 denotes a transport company terminal, 40 denotes a financier terminal, 50 denotes an authentication server, 51 denotes an authentication information database, 100 denotes a network and 300 denotes a direct marketing system utilizing the network.

Referring to FIG. 1, the direct marketing system 300 utilizing the network 100 in this embodiment comprises the purchaser terminal 10, the dealer server 20, the transport company terminal 30, the financier terminal 40, the authentication server 50, the authentication information database (DB) 51 and the network 100 such as the Internet connecting the above-stated constituent elements to one another. A purchaser and a dealer acquire credibility information on the other parties at their respective terminals (to be specific, the purchaser terminal 10, the dealer server 20, the transport company terminal 30, the financier terminal 40 and the authentication server 50) before the purchaser and the dealer purchase and sell an article, whereby the purchaser and the dealer check the credibility of the other parties and then purchase and sell the article.

The purchaser terminal 10 is an information processor such as a personal computer.

The purchaser terminal 10 functions to access article information provided by the dealer server 20 on the network 100 and to display the article information on a screen.

The article information is exemplified by information on articles such as compact discs, books and software. The article information includes information on the name, type, article number, color, price and the like of the article.

The purchaser terminal 10 functions to access the authentication server 50, to acquire credibility information on the dealer through the network 100 and to display the acquired information on the screen.

The credibility information on the dealer includes, for example, company guide information such as the company name, the address and main customers of the dealer and information on the annual sales of the dealer and information on the dealing status of the dealer with financial institutions.

The purchaser terminal 10 functions to transmit to the dealer server 20 through network 100 purchase/order information including article identification information on an article which the purchaser wants to purchase, a payment method for the price of the article, an article delivery place and purchaser identification information such as an address, a name and the like specifying the purchaser oneself.

The dealer server 20 is used by the dealer of the article and constituted by an information processor such as a workstation server.

The dealer server 20 functions to receive the purchase/order information transmitted from the purchaser terminal 10 by the operation of the purchaser, to extract the purchaser identification information from the purchase/order information and to transmit the extracted information to the purchaser terminal 10.

The dealer server 20 functions to access the authentication server 50, to acquire credibility information on the purchaser through the network 100 and to display the credibility information on the screen of the server 20.

The credibility information on the purchaser includes, for example, basic personal information such as the address, the name and the telephone number of the purchaser and information on the dealing status and the like of the purchaser with credit firms, banks and the like.

The transport company terminal 30 is used by a transport company responsible for delivering the article and constituted by an information processor such as a workstation server.

The transport company terminal 30 functions to receive delivery direction information from the dealer server 20 through the network 100. The delivery direction information is information for directing the transport company to receive the article designated by the purchaser and order information from the dealer and delivering the article to the designated delivery destination.

The transport company terminal 30 functions to transmit to the authentication server 50 information indicating that the transport company received the price of the article when the article is delivered if the payment method is cash on delivery.

The financier terminal 40 is used by a financier and a financial institution such as a credit firm, a bank, a post office dealing with a credit card and the like. The financier terminal 40 is constituted by an information processor such as a workstation server.

The financier terminal 40 acquires, as information which forms a basis for establishing credibility information on the purchaser and the dealer, dealing information such as remittance from the purchaser to the dealer, bank account transfer or postal transfer and dealing information of the dealer with financiers and financial institutions, and transmits the acquired information to the authentication server 50 through the network 100.

The authentication server 50 is used by a company or an institution independent of the user or purchaser, the dealer, the transport company, the financiers and financial institutions, and constituted by an information processor such as a workstation server.

The authentication server 50 functions to transmit credibility information through the network 100 when receiving a request to acquire the credibility information from the purchaser terminal 10 or the dealer server 20.

The authentication server 50 functions to receive dealing information which forms a basis for the credibility information from the transport company terminal 30 and the financier terminal 40 through network 100 and to establish an authentication information database (DB) 51 for the credibility information on the purchaser and the dealer.

Next, the operation of the direct marketing system 300 utilizing the network 100 will be described.

Referring to FIG. 1, in this embodiment, the purchaser first acquires credibility information on the dealer of an article from authentication server 50 when placing an order with the dealer for the article from the purchaser terminal 10 of the purchaser through the network 100. If the credibility of the dealer is found satisfactory based on the credibility information, the purchaser transmits information for specifying the article which the purchaser wants to purchase and the purchaser oneself and purchase/order information such as a settlement method to the dealer server 20 through the network 100.

The dealer server 20 acquires credibility information on the purchaser from the authentication server 50 at the time of processing the purchase/order information received from the purchaser through the network 100. If the credibility of the purchaser is found satisfactory based on the credibility information, the dealer server 20 processes the order.

The dealer server 20 transmits delivery direction information to the transport company terminal 30 through the network 100 so that the transport company delivers the article ordered by the purchaser to the purchaser.

The transport company terminal 30, which has received the delivery direction information, receives the article from the dealer server 20 and delivers the article to a place designated by the purchaser terminal 10.

Further, at the time of settling accounts for the price of the article by the order processing, the dealer server 20 settles accounts for the price of the article according to the settlement method which the dealer accepted from the purchaser.

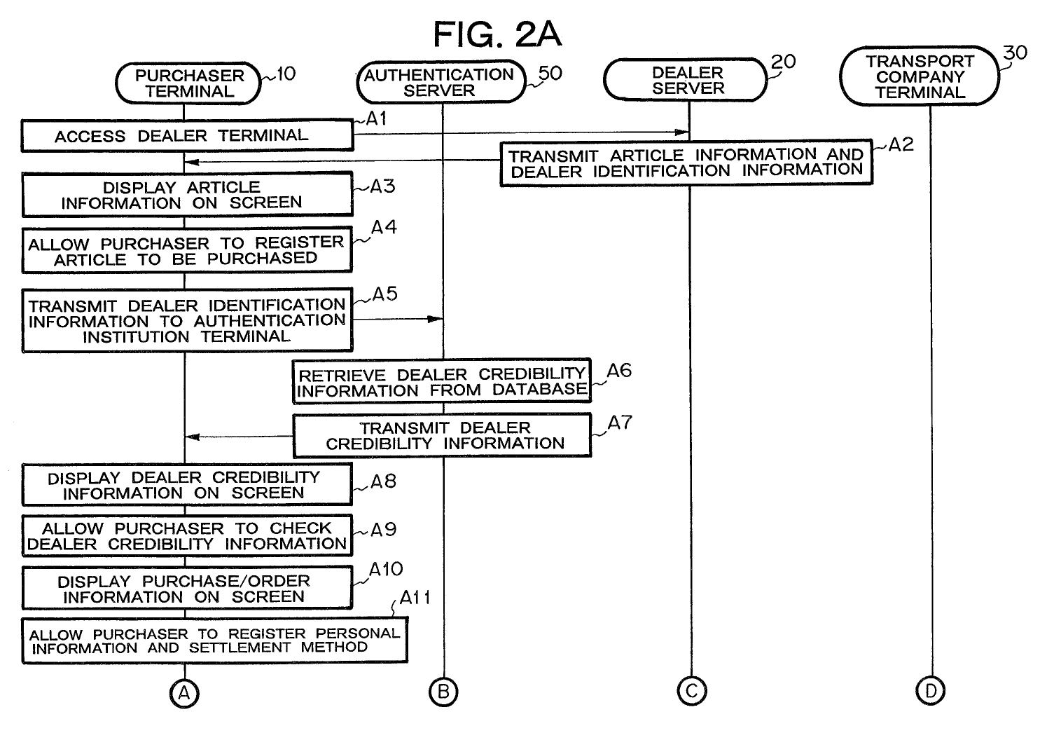

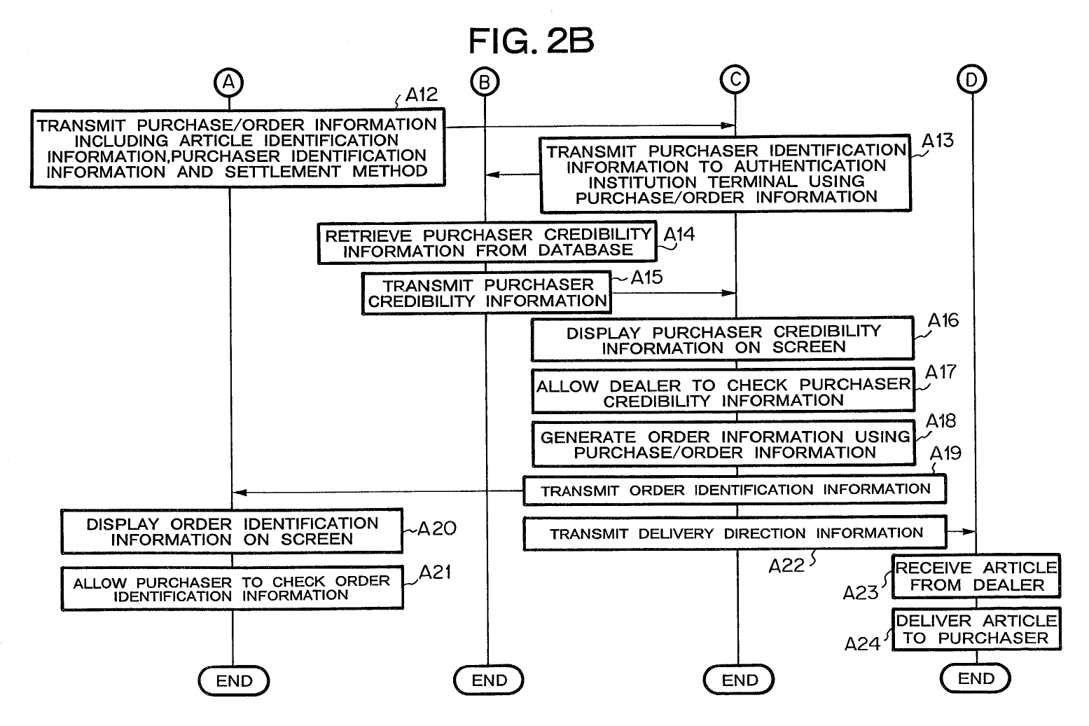

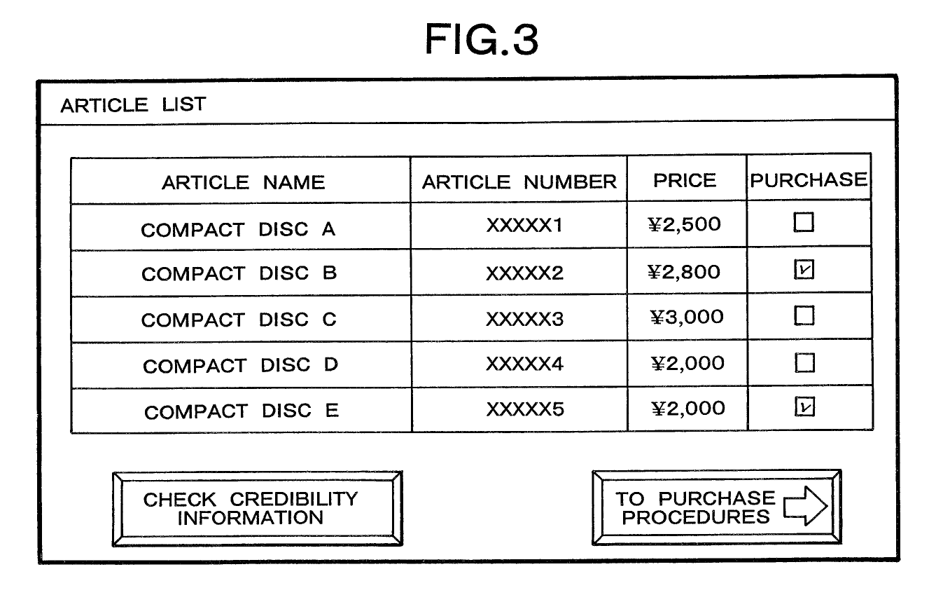

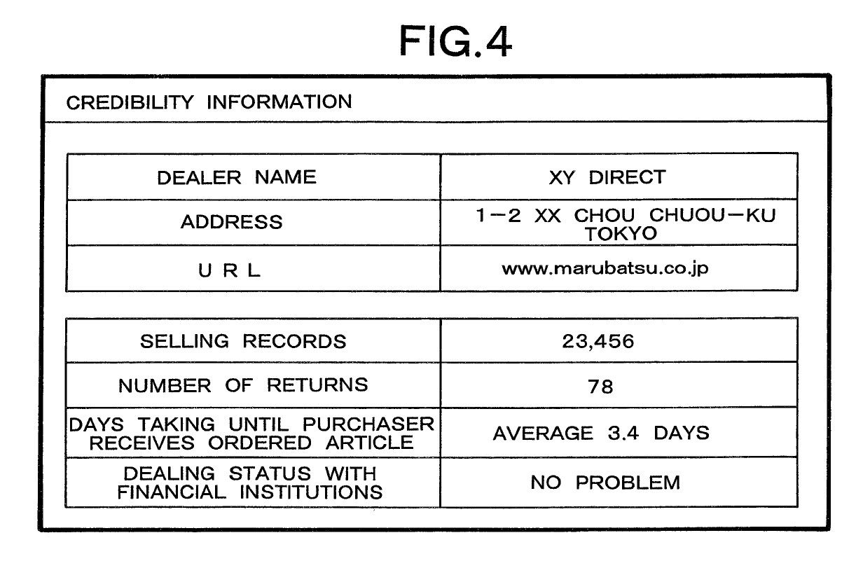

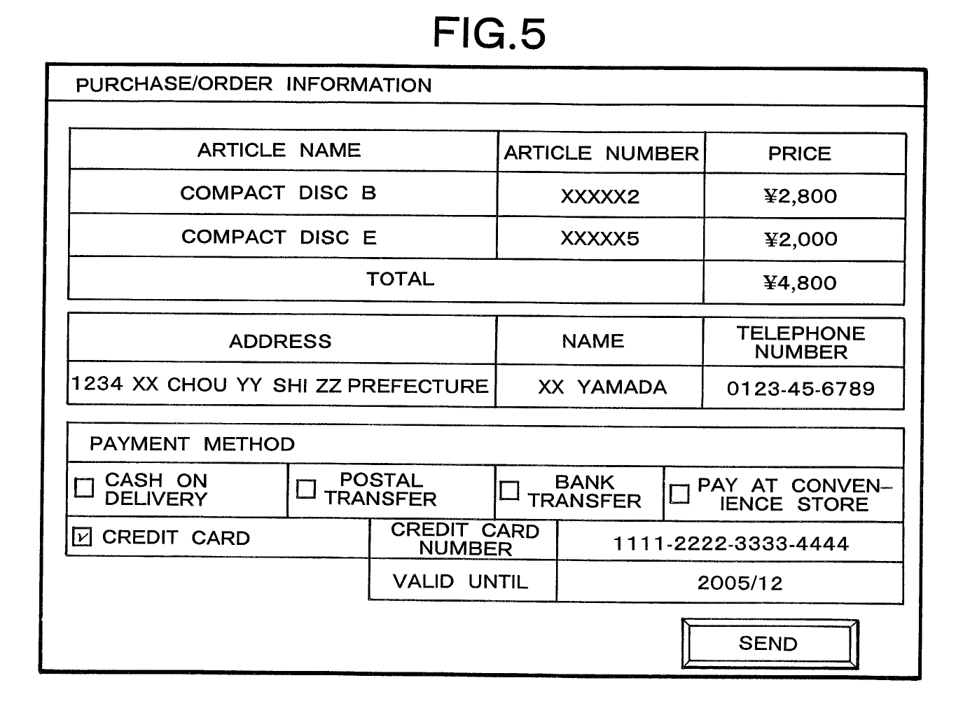

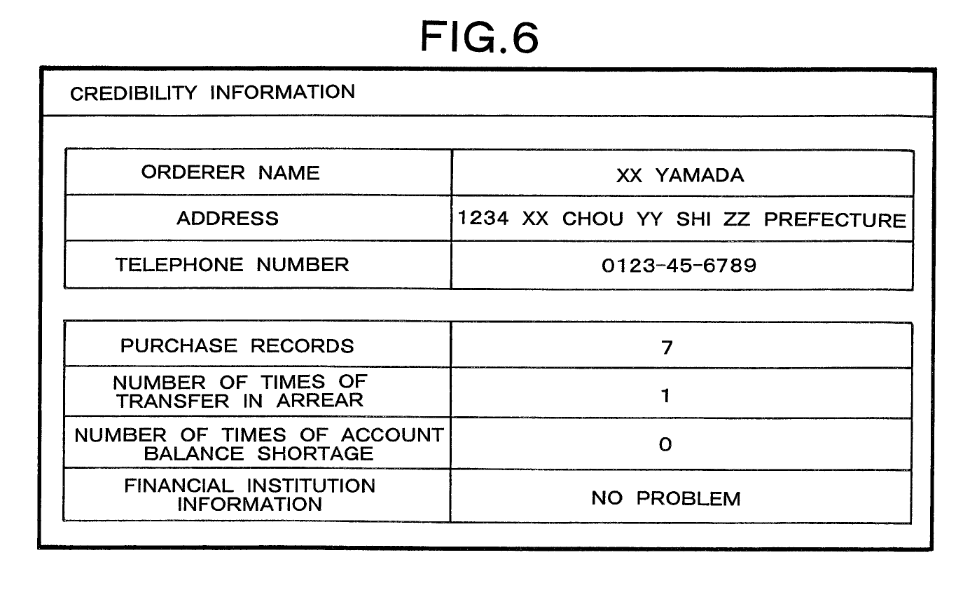

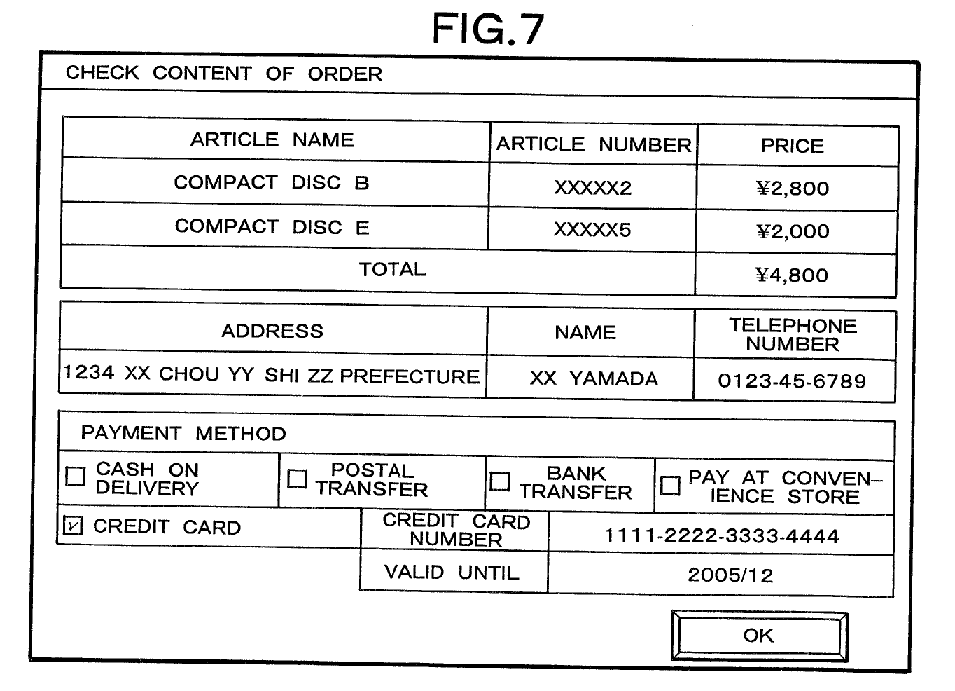

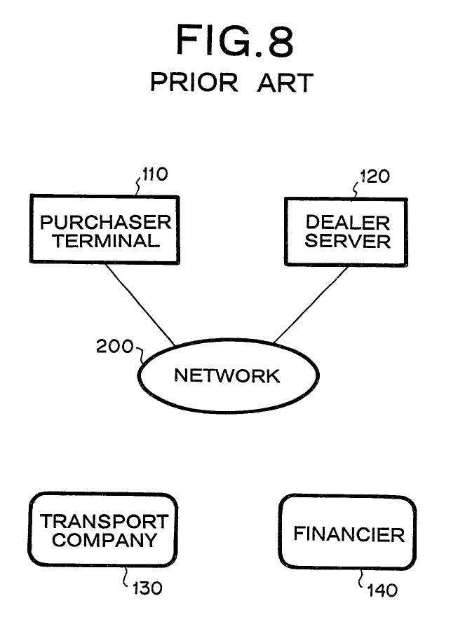

Next, an online shopping method according to this embodiment will be described in detail with reference to FIGS. 1 to 7. In the following description, it is assumed that the network 100 is the Internet. FIG. 2 is a flow chart for describing the online shopping method utilizing the network 100 according to one embodiment of the present invention. FIG. 3 shows an example of various items of article information displayed on the purchaser terminal 10. FIG. 4 shows an example of credibility information on the dealer displayed on the purchaser terminal 10. FIG. 5 shows an example of purchase/order information displayed on the purchaser terminal 10. FIG. 6 shows an example of credibility information on the purchaser displayed on the dealer server 20. FIG. 7 shows an example of information for checking the contents of the order of an article displayed on the purchaser terminal 10.

Referring to FIG. 2, in this embodiment, the purchaser first accesses a merchandise sales website opened by the dealer on the network (or the Internet) 100 (in a step Al).

In response to the access, the dealer server 20 transmits article information and identification information on the dealer (e.g., the name of the dealer and URL: Uniform Resource Locator) to the purchaser terminal 10 (in a step A2).

First, various items of article information as shown in FIG. 3 are displayed on the screen of the purchaser terminal 10 (in a step A3).

The purchaser decides on an article which the purchaser wants to purchase while viewing the various article information displayed on the screen of the purchaser terminal 10 and registers the article which the purchaser wants to purchase on the screen (in a step A4).

In the example of FIG. 3, when the purchaser clicks on the purchase boxes of compact discs B and E with a mouse, the boxes are marked and the purchase of the compact discs B and E is thereby registered. Article information on the registered articles which the purchaser intends to purchase is temporarily stored in the purchaser terminal 10 as part of purchase/order information.

Next, when the purchaser clicks on a “check credibility information” button on the screen as shown in FIG. 3 with a mouse, identification information on the dealer is transmitted from the dealer terminal 10 to the authentication server 50 (in a step A5).

When receiving the identification information on the dealer, the authentication server 50 retrieves credibility information on the dealer corresponding to the received identification information on the dealer from the authentication information database (DB) 51 which stores credibility information (in a step A6). The credibility information on the dealer thus retrieved is transmitted to the purchaser terminal 10 (in a step A7). The credibility information on the dealer is displayed on the screen of the purchaser terminal 10 as shown in FIG. 4 (in a step A8).

The purchaser checks the credibility information on the dealer (in a step A9). If the credibility of the dealer is satisfactory and the purchaser clicks on a “to purchase procedures” button on the screen shown in FIG. 3 with the mouse, then purchase/order information as shown in FIG. 5 is displayed on the screen (in a step A10).

As shown in FIG. 5, the purchaser checks the article information (which is the information registered in the step A4) displayed on the screen and designates personal identification information such as the address, the name and the like of the purchaser and a settlement method (in a step All). When the purchaser clicks on a “send button” shown in FIG. 5 with the mouse, the purchase/order information including the article information, the personal identification information and the settlement method is transmitted from the purchaser terminal 10 to the dealer server 20 through the network (or the Internet) 100 (in a step A12).

When receiving the purchase/order information, the dealer server 20 first transmits the personal identification information on the purchaser to the authentication server 50 (in a step A13). At this moment, the purchase/order information is stored in the dealer server 20.

When receiving the identification information on the purchaser, the authentication server 50 retrieves credibility information on the purchaser corresponding to the received identification information on the purchaser from the authentication information database (DB) 51 which stores credibility information (in a step A14).

The authentication server 50 transmits the retrieved credibility information on the purchaser to the dealer server 20 (in a step A15).

The credibility information on the purchaser is displayed on the screen of the dealer server 20 as shown in FIG. 6 (in a step A16).

The dealer checks the credibility information on the purchaser (in a step A17). If the credibility of the purchaser is satisfactory, the dealer generates order identification information for identifying the purchaser and the contents of the order using the purchase/order information stored in the step A13 (in a step A18).

The dealer server 20 transmits the generated order identification information to the purchaser terminal 10 (in a step A19).

The order identification information is displayed on the screen of the purchaser terminal 10 as shown in FIG. 7 (in a step A20). The purchaser then checks the contents of the order identification information (in a step A21).

The order identification information may be checked by the purchaser on the dealer's website or may be notified to the purchaser by electronic mail or the like.

On the basis of the generated order identification information, the dealer server 20 transmits delivery direction information including information on the purchaser of the article, a delivery destination and the like to the transport company terminal 30 through the network (or the Internet) 100 (in a step A22).

The transport company terminal 30 receives the corresponding article from the dealer (in a step A23) and delivers the article to the purchaser based on the received delivery direction information (in a step A24).

Next, description will be given to a method of generating credibility information stored in the authentication information database (DB) 51 within the authentication server 50.

Information which forms a basis for establishing credibility information consists of article price dealing status. The information is transmitted to the authentication server 50 through the network (or the Internet) 100 from a different terminal depending on a payment method for the price of an article.

For example, if a payment method for the price of an article is cash on delivery, the transport company to receive the price from the purchaser generates dealing information and transmits the generated information from the transport company terminal 30 to the authentication server 50.

If the payment method is bank account transfer using a credit card, the price dealing information is transmitted from two financier terminals 40 of a credit firm dealing with the credit card and a bank having the bank account of the purchaser to the authentication server 50, respectively. Since credit firms, in particular, establish credibility information on clients independently (or so-called a blacklist), it is preferable that such information is transmitted simultaneously.

In this way, the authentication server 50 receives the dealing information which forms a basis for the credibility information from the transport company terminal 30 and the financier terminals 40 through the network 100 and establishes an authentication information database 51 (DB) for the credibility information on the purchaser and the dealer. Then, the authentication server 50 sends back the credibility information through the network 100 when receiving a credibility information acquisition request from the purchaser terminal 10 or the dealer server 20.

To establish the authentication information database (DB) 51 within the authentication server 50, a server security function such as SSL (Secure Socket Layer) or encryption technology such as RSA encryption technology is used so as to prevent the other parties from easily acquiring authentication information on the network (or the Internet) 100 or looking at the contents of the information. Encryption is also applied to a case of communicating the purchase/order information and the purchaser identification information. Personal authentication technology is also used to check whether the purchaser is really the person himself or herself. Since these security, encryption and authentication technologies are well-known, they will not be described herein.

Since the present invention is constituted as stated so far, the present invention has the following advantages.

First, a customer or purchaser and a dealer can purchase and sell an article (articles) after checking the credibility of the other parties. The reason for realizing the first advantage is that the client or purchaser and the dealer can acquire authentication information on the other parties from an authentication institution.

The second advantage is that since the client or purchaser and the dealer can acquire credibility information promptly on the network, the purchaser and the dealer can purchase and sell articles safer than conventional methods only with a labor to acquire and check credibility. The reason for realizing the second advantage is that the authentication institution for acquiring credibility information is allowed to exist on the network.

What is claimed is:

1. An online shopping method comprising steps of:
transmitting identification information on a dealer from a dealer server to a purchaser terminal;
transmitting the identification information on the dealer from the purchaser terminal to an authentication server;
retrieving credibility information on the dealer corresponding to the identification information on the dealer by the authentication server; and
transmitting the credibility information on the dealer from the authentication server to the purchaser terminal.

2. An online shopping method according to claim 1, wherein
the credibility information on the dealer includes at least one of a company name, an address, main customers and annual sales of the dealer and a dealing status of the dealer with a correspondent financial institution.

3. An online shopping method comprising steps of:
transmitting identification information on a purchaser from a purchaser terminal to a dealer server;
transmitting the identification information on the purchaser from the dealer server to an authentication server;
retrieving credibility information on the purchaser corresponding to the identification information on the purchaser by the authentication server; and
transmitting the credibility information on the purchaser from the authentication server to the dealer server.

4. An online shopping method according to claim 3, wherein
the credibility information on the purchaser includes at least one of an address, a name, and a telephone number of the purchaser and a dealing status of the purchaser with a credit firm.

5. An online shopping method comprising steps of:
transmitting identification information on a dealer from a dealer server to a purchaser terminal;
transmitting the identification information on the dealer from the purchaser terminal to an authentication server;
retrieving credibility information on the dealer corresponding to the identification information on the dealer by the authentication server;
transmitting identification information on the purchaser from the purchaser terminal to the dealer server;
transmitting identification information on the dealer from the authentication server to the purchaser terminal;
transmitting the identification information on the purchaser from the dealer server to the authentication server;
retrieving credibility information on the purchaser corresponding to the identification information on the purchaser by the authentication server; and
transmitting the credibility information on the purchaser from the authentication server to the dealer server.

6. An online shopping method according to claim 5, wherein
the credibility information on the dealer includes at least one of a company name, an address, main customers, and annual sales of the dealer and a dealing status of the dealer with a financial institution.

7. An online shopping method according to claim 5, wherein
the credibility information on the purchaser includes at least one of an address, a name, a telephone number of the purchaser and a dealing status of the purchaser with a credit firm.

8. An online shopping system comprising a purchaser terminal, a dealer server and an authentication server connected to one another through a network, wherein
the dealer server comprises means for transmitting identification information on a dealer to the purchaser terminal;
the purchaser terminal comprises means for transmitting identification information on the dealer to the authentication server; and
the authentication server comprises:
means for retrieving credibility information on the dealer corresponding to the identification information on the dealer, and
means for transmitting the credibility information on the dealer to the purchaser terminal.

9. An online shopping system according to claim 8, wherein
the credibility information on the dealer includes at least one of a company name, an address, main customers, and annual sales of the dealer and a dealing status of the dealer with a financial institution.

10. An online shopping system comprising a purchaser terminal, a dealer server and an authentication server connected to one another through a network, wherein
the purchaser terminal comprises means for transmitting identification information on a purchaser from the purchaser terminal to the dealer server;
the dealer server comprises means for transmitting the identification information on the purchaser from the dealer server to the authentication server;
the authentication server comprises:
means for retrieving credibility information on the purchaser corresponding to the identification information on the purchaser, and
means for transmitting the credibility information on the purchaser to the dealer server.

11. An online shopping system according to claim 10, wherein
the credibility information on the purchaser includes at least one of an address, a name, and a telephone number of the purchaser and a dealing status of the purchaser with a credit firm.

12. An online shopping system comprising a purchaser terminal, a dealer server and an authentication server connected to one another through a network, wherein
the dealer server comprises means for transmitting identification information on a dealer to the purchaser terminal;
the purchaser terminal comprises means for transmitting identification information on the dealer to the authentication server;
the authentication server comprises:
means for retrieving credibility information on the dealer corresponding to the identification information on the dealer, and
means for transmitting the credibility information on the dealer to the purchaser terminal, and wherein
the purchaser terminal comprises means for transmitting identification information on a purchaser to the dealer server;
the dealer server comprises means for transmitting the identification information on the purchaser to the authentication server; and
the authentication server comprises:
means for retrieving credibility information on the purchaser corresponding to the identification information on the purchaser, and
means for transmitting the credibility information on the purchaser to the dealer server.

13. An online shopping system according to claim 12, wherein
the credibility information on the dealer includes at least one of a company name, an address, main customers, and annual sales of the dealer and a dealing status of the dealer with a financial institution.

14. An online shopping system according to claim 12, wherein
the credibility information on the purchaser includes at least one of an address, a name, and a telephone number of the purchaser and a dealing status of the purchaser with a credit firm.
